(19) United States
(12) Patent Application Publication
(10) Pub. No.: US 2026/0285047 A1
(43) Pub. Date: Sep. 24, 2026

(54) LIQUID EJECTION HEAD AND LIQUID EJECTION APPARATUS

(71) Applicant: CANON KABUSHIKI KAISHA, Tokyo (JP)

(72) Inventors: KOICHI ISHIDA, Tokyo (JP); YASUHIKO OSAKI, Kanagawa (JP); YUHEI OIKAWA, Kanagawa (JP); YUMI KOMAMIYA, Kanagawa (JP)

(21) Appl. No.: 19/553,060

(22) Filed: Feb. 27, 2026

(30) Foreign Application Priority Data
Mar. 18, 2025 (JP) 2025-044142

(51) Int. Cl. B41J 2/175; B41J 2/17

(52) U.S. Cl. CPC B41J 2/175; B41J 2/1721

(57) ABSTRACT

A liquid ejection head includes an element substrate including a first ejection port array, a second ejection port array, a plurality of pressure chambers each including an energy generating element configured to generate thermal energy for ejecting the liquid, a first supply passage configured to supply the liquid to the plurality of pressure chambers of the first ejection port array, a second supply passage configured to supply the liquid to the plurality of pressure chambers of the second ejection port array, a first liquid supply opening configured to supply the liquid to the first supply passage, and a second liquid supply opening configured to supply the liquid to the second supply passage, wherein an opening area of the first liquid supply opening is equal to or smaller than an opening area of the second liquid supply opening.

### BACKGROUND

### Field of the Technology

The present disclosure relates to a liquid ejection head and a liquid ejection apparatus.

### Description of the Related Art

In a liquid ejection head configured to discharge a liquid such as ink, volatile components may evaporate from the ejection ports, causing the liquid near the ejection ports to become concentrated and thicken. As a result, the ejection speed of droplets may change, and the landing accuracy may deteriorate. Particularly, when the idle time between the ejection of successive droplets is long or when the liquid contains a high proportion of solids, the increase in viscosity becomes pronounced. As one countermeasure against such thickening phenomena, a method is known in which the liquid in the pressure chamber where the ejection ports are arranged is circulated, thereby discharging the thickened liquid that has stagnated in the pressure chamber.

Recently, inkjet printers have been used not only for home printing applications but also for business printing applications, such as office use and retail photo printing, as well as industrial applications, such as electronic circuit drawing and flat panel display manufacturing, and their applications are expanding. Among these, heads for business-use inkjet printers are required to have high-speed printing performance, and to meet this requirement, ink is ejected at higher frequencies. Alternatively, for high-speed printing, the width of the recording head is matched to the width of the recording medium to form a full-line head, and a greater number of ejection ports are arranged than in conventional heads.

In such liquid ejection heads, there are issues, such as variations in negative pressure of the liquid flowing through the pressure chamber and the occurrence of temperature distribution within the recording element. In this regard, Japanese Patent Laid-Open No. 2017-124614 describes a configuration in which a plurality of ink supply openings is provided offset from the same straight line extending in the direction of movement of the recording medium relative to other openings. As a result, variations in negative pressure and temperature do not overlap in the conveyance direction, and the occurrence of uneven recording can be suppressed. Temperature control of the recording element substrate is performed to suppress deterioration in image quality due to temperature variations.

However, in the liquid ejection head described in Japanese Patent Laid-Open No. 2017-124614, condensation may occur. When condensation occurs, the liquid derived from the condensation may cause instability in liquid ejection.

### SUMMARY

Accordingly, the present disclosure provides a liquid ejection head and a liquid ejection apparatus that suppress occurrence of condensation and improve ejection stability of a liquid.

According to an aspect of the present disclosure, a liquid ejection head includes an element substrate including a first ejection port array in which a plurality of ejection ports configured to eject a liquid are arranged along a first direction, a second ejection port array that is disposed, with respect to the first ejection port array, in a second direction intersecting the first direction and in which a plurality of the ejection ports configured to eject the liquid are arranged along the first direction, a plurality of pressure chambers respectively provided corresponding to the plurality of ejection ports and each including an energy generating element configured to generate thermal energy for ejecting the liquid from a corresponding ejection port, a first supply passage configured to supply the liquid to the plurality of pressure chambers of the first ejection port array, a second supply passage configured to supply the liquid to the plurality of pressure chambers of the second ejection port array, a first liquid supply opening configured to supply the liquid to the first supply passage, and a second liquid supply opening configured to supply the liquid to the second supply passage, wherein an opening area of the first liquid supply opening is equal to or smaller than an opening area of the second liquid supply opening.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a liquid ejection apparatus.

FIG. 2 is a conceptual diagram of a control system.

FIG. 3 is a schematic diagram of an ink supply system.

FIG. 4A is a perspective view of a liquid ejection head.

FIG. 4B is a perspective view of the liquid ejection head.

FIG. 5 is an exploded view of the liquid ejection head.

FIG. 6A to FIG. 6D are exploded views of a flow path member.

FIG. 7A is a transparent perspective view of a flow path.

FIG. 7B is a cross-sectional view of the flow path.

FIG. 8A is a perspective view of an ejection module.

FIG. 8B is an exploded view of the ejection module.

FIG. 9A to FIG. 9C are transparent perspective views of a recording element substrate.

FIG. 10 is a cross-sectional view of the recording element substrate.

FIG. 11 is a schematic diagram illustrating a configuration of openings and a temperature distribution of a recording element substrate in a comparative example.

FIG. 12 is a schematic diagram illustrating a configuration of openings and a temperature distribution of a recording element substrate in an example.

### DESCRIPTION OF THE EMBODIMENTS

An embodiment of the present disclosure will be described below with reference to the drawings. The following description is not intended to limit the scope of the present disclosure.

A liquid ejection head of the present disclosure configured to eject a liquid, such as ink, and a liquid ejection apparatus including the liquid ejection head can be applied to apparatuses, such as a printer, a copying machine, a facsimile having a communication system, and a word processor having a printer unit. The liquid ejection apparatus can also be applied to an industrial recording apparatus combined with various processing apparatuses. For example, the liquid ejection apparatus can be used for applications, such as biochip fabrication, electronic circuit printing, and semiconductor substrate fabrication.

The embodiment of the present disclosure is an inkjet recording apparatus (recording apparatus) of a configuration in which a liquid, such as ink, is circulated between a tank and the liquid ejection head. However, the present disclosure is not limited to such a configuration. For example, a configuration can be adopted in which ink is not circulated, two tanks can be provided on an upstream side and a downstream side of the liquid ejection head, and ink can be caused to flow from one tank to the other tank to thereby cause ink in a pressure chamber to flow.

The embodiment of the present disclosure is a so-called line-type (page-wide type) head having a length corresponding to a width of a recording medium. However, the present disclosure can also be applied to a so-called serial-type liquid ejection head that performs recording while scanning the recording medium. As a serial-type liquid ejection head, for example, a configuration including one recording element substrate for black ink and one recording element substrate for color ink can be employed. The present disclosure is not limited to such a configuration. A configuration can also be employed in which a short line head having a length shorter than a width of the recording medium is produced by disposing several recording element substrates such that ejection ports overlap in an ejection-port-array direction, and the short line head scans the recording medium.

### Description of Basic Structure according to the Present Disclosure

The embodiment of the present disclosure will be described below with reference to the drawings.

### First Embodiment

### Overall Configuration of Liquid Ejection Apparatus

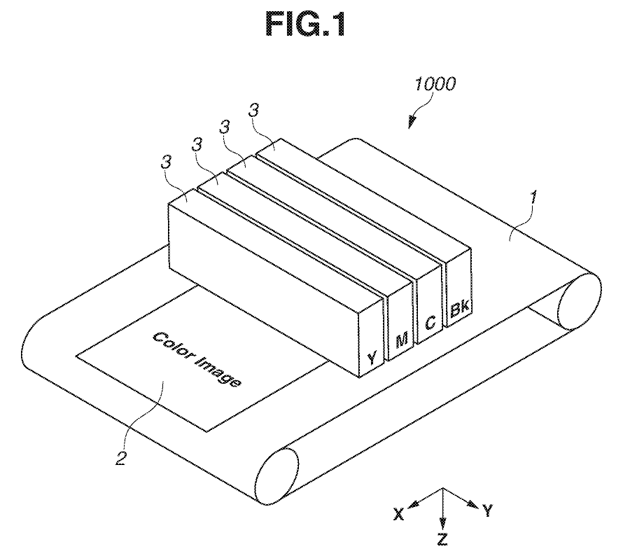

FIG. 1 illustrates a liquid ejection apparatus 1000 according to a first embodiment. In FIG. 1, an X direction is a conveyance direction of a recording medium 2, a Y direction is a width direction of the recording medium 2, and a Z direction is a vertical direction. The liquid ejection apparatus 1000 of the present embodiment includes a paper conveying unit 1 configured to convey the recording medium 2 and a line-type liquid ejection head 3 disposed substantially orthogonal to the X direction that is the conveyance direction of the recording medium 2. The liquid ejection head 3 can record a color image on the recording medium 2 by discharging inks of cyan (C), magenta (M), yellow (Y), and black (Bk). Four liquid ejection heads 3 are arranged in the X direction in an order of cyan, magenta, yellow, and black, and inks are applied to the recording medium 2 in this order. In each liquid ejection head 3, a plurality of ejection ports configured to eject ink is arranged in the Y direction.

Although FIG. 1 illustrates cut paper as the recording medium 2, the recording medium 2 may be continuous paper supplied from roll paper. The recording medium is not limited to paper, and the recording medium may be a film.

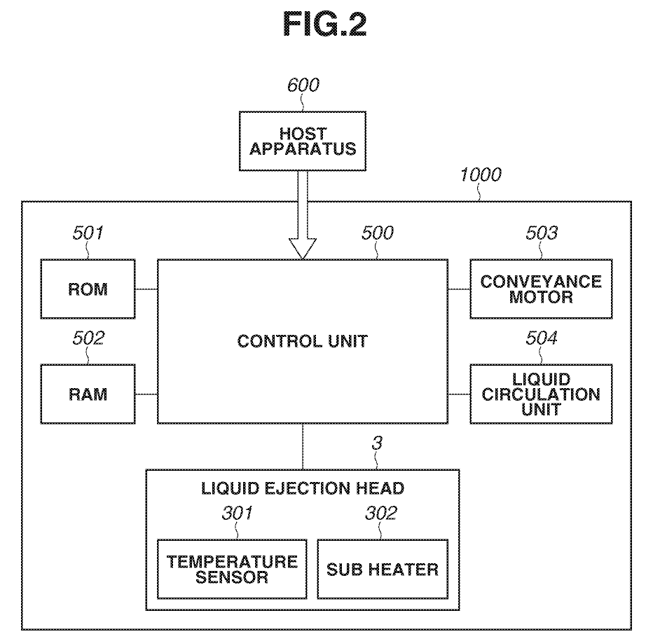

FIG. 2 is a block diagram illustrating a control configuration in the liquid ejection apparatus 1000. A control unit 500 includes a central processing unit (CPU) and the like and controls an entirety of the liquid ejection apparatus 1000 while using a random access memory (RAM) 502 as a work area in accordance with a program and various parameters stored in a read-only memory (ROM) 501. The control unit 500 performs predetermined image processing on image data received from an externally connected host device 600 in accordance with the program and the parameters stored in the ROM 501 to generate ejection data based on which the liquid ejection head 3 can perform ejection. The control unit 500 drives the liquid ejection head 3 in accordance with the ejection data to eject ink at a predetermined frequency.

During an ejection operation by the liquid ejection head 3, the control unit 500 drives a conveyance motor 503 to convey the recording medium 2 in the X direction at a speed corresponding to a drive frequency. Accordingly, an image corresponding to the image data received from the host device 600 is recorded on the recording medium 2. In the ROM 501, information about a usable region of ejection ports to be used for ejection in the liquid ejection head 3 is stored so as to be rewritable for each liquid ejection head 3. A method of setting the usable region will be described in detail below.

### Liquid Circulation System

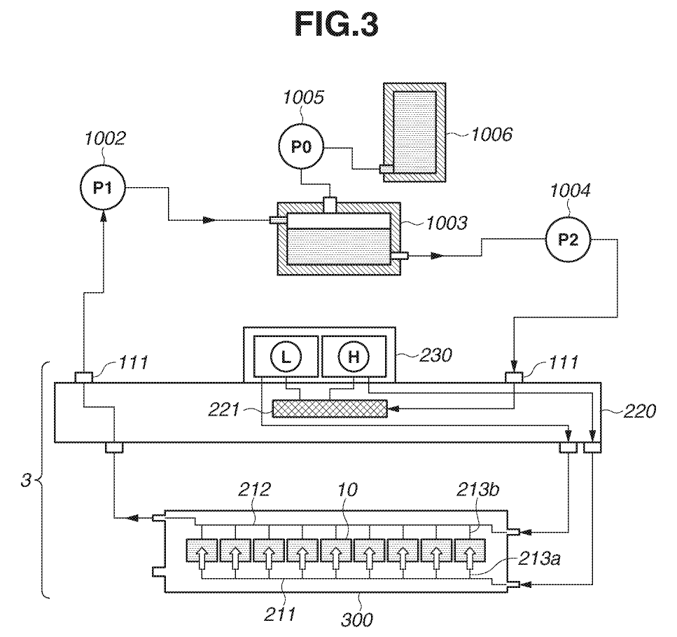

FIG. 3 is a schematic diagram illustrating a circulation path applied to the liquid ejection apparatus 1000 of the present embodiment, and illustrates a configuration in which the liquid ejection head 3 is fluidly connected to a first circulation pump 1002, a buffer tank 1003, and the like. In FIG. 3, to simplify description, only a path through which ink of one color among CMYK inks flows is illustrated. In an actual configuration, circulation paths corresponding to a plurality of colors are provided in the liquid ejection head 3 and a main body of the liquid ejection apparatus. The buffer tank 1003 as a sub tank connected to a main tank 1006 includes an air communication opening (not illustrated) that communicates an inside of the buffer tank 1003 with an outside of the buffer tank 1003, and can eject air bubbles in ink to an outside. The buffer tank 1003 is also connected to a replenishment pump 1005. The replenishment pump 1005 transfers, from the main tank 1006 to the buffer tank 1003, an amount of ink corresponding to consumed ink when liquid is consumed in the liquid ejection head 3 by ejecting (discharging) ink from ejection ports of the liquid ejection head 3, such as during recording by ink ejection or during suction recovery.

The first circulation pump 1002 has a role of drawing liquid from a liquid connection portion 111 of the liquid ejection head 3 and causing the liquid to flow to the buffer tank 1003. During driving of the liquid ejection head 3, the first circulation pump 1002 causes a certain amount of ink to flow in a common collection flow path 212.

A negative pressure control unit 230 is provided between a path of a second circulation pump 1004 and a path of a liquid ejection unit 300. Accordingly, the negative pressure control unit 230 has a function of operating to maintain a pressure, on a downstream side (a liquid ejection unit 300 side) of the negative pressure control unit 230, at a predetermined constant pressure even in a case where a flow rate of a circulation system fluctuates due to a difference in a duty (Duty) for recording.

As illustrated in FIG. 3, the negative pressure control unit 230 includes two pressure adjustment mechanisms each having a control pressure set to be different from each other. Of the two negative pressure adjustment mechanisms, a relatively high-pressure setting side (denoted by H in FIG. 3) and a relatively low-pressure setting side (denoted by L in FIG. 3) are respectively connected, via a liquid supply unit 220, to a common supply flow path 211 and the common collection flow path 212 in the liquid ejection unit 300. The liquid ejection unit 300 includes the common supply flow path 211, the common collection flow path 212, and an individual supply flow path 213a and an individual collection flow path 213b that communicate with each recording element substrate. Because an individual flow path 213 communicates with the common supply flow path 211 and the common collection flow path 212, a portion of a liquid caused to flow by the second circulation pump 1004 flows from the common supply flow path 211 to the common collection flow path 212 through an internal flow path of the recording element substrate 10 (arrows in FIG. 3). This is because a pressure difference is provided between the pressure adjustment mechanism H connected to the common supply flow path 211 and the pressure adjustment mechanism L connected to the common collection flow path 212, and the first circulation pump 1002 is connected only to the common collection flow path 212.

Accordingly, the liquid is supplied from a supply system of the liquid ejection apparatus 1000 to the liquid ejection head 3, and the liquid that has passed through the liquid ejection head 3 is collected to the supply system of the liquid ejection apparatus 1000. Thus, the liquid can be circulated via a path of the liquid ejection apparatus 1000 and a path of the liquid ejection head 3. In the liquid ejection unit 300 of the present embodiment, a liquid flow passing through the common collection flow path 212 and a liquid flow from the common supply flow path 211 through each recording element substrate 10 to the common collection flow path 212 are generated. Accordingly, heat generated in each recording element substrate 10 can be ejected to an outside of each recording element substrate 10 by the flow from the common supply flow path 211 to the common collection flow path 212. With such configuration, an ink flow can be generated even in an ejection port and a pressure chamber in which recording is not performed during recording by the liquid ejection head 3, and thus an increase in ink viscosity in such a portion can be suppressed. Viscosity-increased ink and foreign matter in ink can be ejected to the common collection flow path 212. Therefore, the liquid ejection head 3 of the present embodiment can perform high-speed and high-quality recording.

### Configuration of Liquid Ejection head

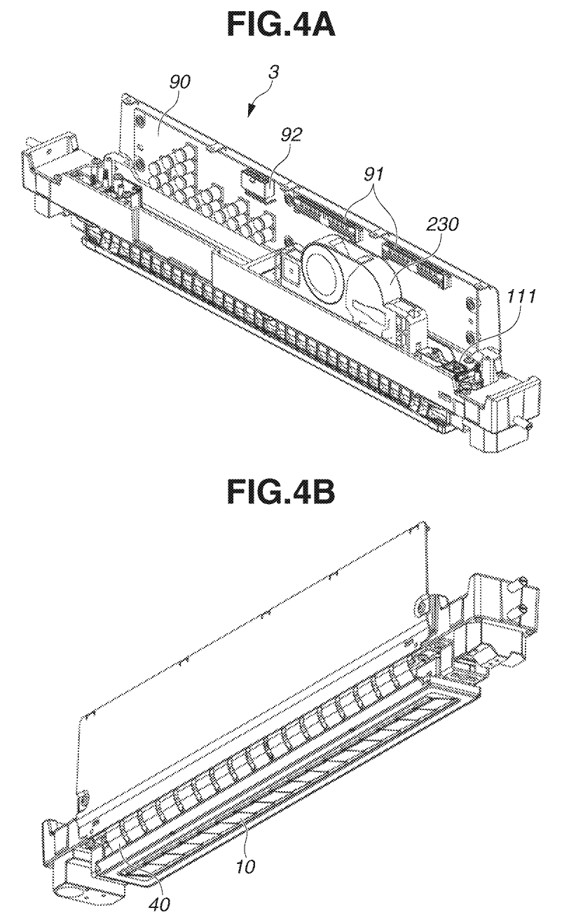

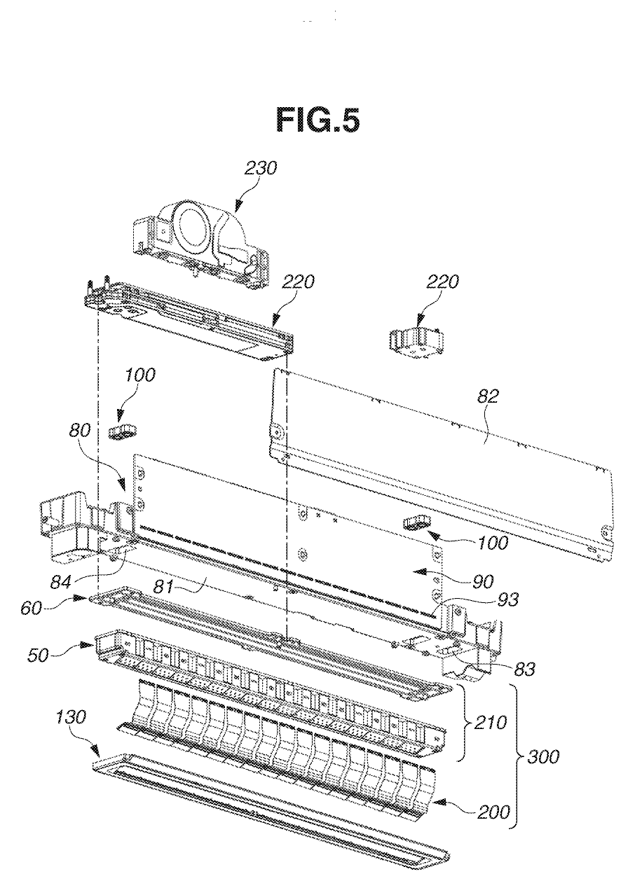

FIG. 4A and FIG. 4B are perspective views of the liquid ejection head 3 according to the present embodiment. FIG. 5 is an exploded perspective view of FIG. 4. The liquid ejection head 3 is a line-type liquid ejection head in which seventeen recording element substrates 10 each capable of ejecting ink are arranged in a straight line (arranged in-line). As illustrated in FIG. 4A and FIG. 4B, the liquid ejection head 3 includes a signal input terminal 91 and a power supply terminal 92 electrically connected to each recording element substrate 10 via a flexible wiring board 40 and an electrical wiring board 90. The signal input terminal 91 and the power supply terminal 92 are electrically connected to a control unit of the liquid ejection apparatus 1000, and supply, to the recording element substrate 10, an ejection drive signal and electric power required for ejection, respectively. By bundling wiring by an electrical circuit in the electrical wiring board 90, the number of the signal input terminals 91 and the power supply terminals 92 can be reduced as compared with the number of the recording element substrates 10. Accordingly, when the liquid ejection head 3 is assembled to the liquid ejection apparatus 1000 or when the liquid ejection head 3 is replaced, the number of electrical connection portions to be detached can be reduced.

As illustrated in FIG. 4A, a liquid connection portion 111 provided on one side of the liquid ejection head 3 is connected to a liquid supply system of the recording apparatus 1000. Accordingly, ink is supplied from the liquid supply system of the recording apparatus 1000 to the liquid ejection head 3, and ink that has passed through the liquid ejection head 3 is collected to the liquid supply system of the recording apparatus 1000. Thus, ink can be circulated via a path of the recording apparatus 1000 and a path of the liquid ejection head 3.

FIG. 5 illustrates an exploded perspective view of components or units constituting the liquid ejection head 3. The liquid ejection unit 300, the liquid supply unit 220, and the electrical wiring board 90 are attached to a housing 80. The liquid supply unit 220 is provided with the liquid connection portion 111, and inside the liquid supply unit 220, for removing foreign matter in supplied ink, color-by-color filters 221 (FIG. 3) each communicating with a corresponding opening of the liquid connection portion 111 are provided. Liquid that has passed through the filter 221 is supplied, corresponding to each color, to the negative pressure control unit 230 disposed on the liquid supply unit 220. The negative pressure control unit 230 is a unit including pressure adjustment valves each for a corresponding color. By operation of a valve, a spring member, and the like provided inside the negative pressure control unit 230, a change in pressure loss in the liquid supply system of the recording apparatus 1000 (a supply system on an upstream side of the liquid ejection head 3) that occurs with a fluctuation of a flow rate of a liquid is significantly attenuated. Accordingly, a negative pressure change on a downstream side (a liquid ejection unit 300 side) of a pressure control unit can be stabilized within a certain range. The negative pressure control unit 230 for each color includes two pressure adjustment valves for the color, and the two pressure adjustment valves are set to different control pressures. A high-pressure side communicates, via the liquid supply unit 220, with the common supply flow path 211 in the liquid ejection unit 300, and a low-pressure side communicates, via the liquid supply unit 220, with the common collection flow path 212.

The housing 80 includes a liquid ejection unit support portion 81 and an electrical wiring board support portion 82, supports the liquid ejection unit 300 and the electrical wiring board 90, and ensures rigidity of the liquid ejection head 3. The electrical wiring board support portion 82 supports the electrical wiring board 90 and is fixed to the liquid ejection unit support portion 81 by screws. The liquid ejection unit support portion 81 is provided with openings 83 and 84 into which joint rubbers 100 are inserted. Liquid supplied from the liquid supply unit 220 is guided to a second flow path member 60 included in the liquid ejection unit 300 via the joint rubbers 100.

Next, a configuration of a flow path member 210 included in the liquid ejection unit 300 will be described. As illustrated in FIG. 5, the flow path member 210 is formed by laminating a first flow path member 50 and the second flow path member 60, and a plurality of ejection modules 200 is bonded, by an adhesive (not illustrated), to a bonding surface of the first flow path member 50. Accordingly, liquid supplied from the liquid supply unit 220 is distributed to the ejection modules 200. The liquid recirculating from the ejection modules 200 flows into the common collection flow path 212 in the flow path member and is ejected to an outside of the head via the liquid connection portion 111 of the liquid ejection head 3. The flow path member 210 is fixed to the liquid ejection unit support portion 81 by screws.

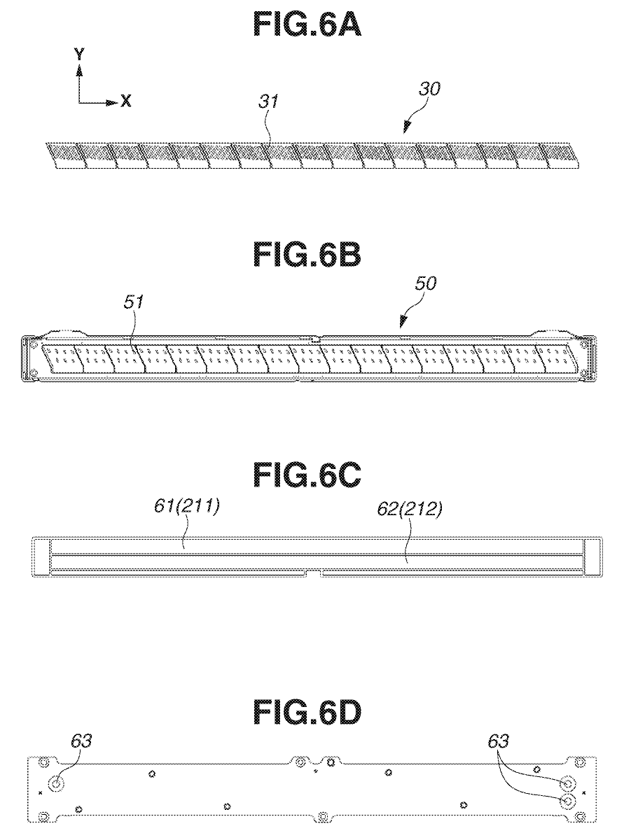

FIG. 6A to FIG. 6D are diagrams illustrating a detailed configuration of the flow path member 210. FIG. 6A illustrates a contact surface of a support member 30 with the recording element substrate 10. FIG. 6B illustrates a contact surface of the first flow path member 50 with the support member 30. FIG. 6C illustrates a middle-layer cross section of the first flow path member 50. FIG. 6D illustrates a surface of the second flow path member 60 on a liquid ejection unit support portion 81 side. FIG. 6A to FIG. 6C are views seen from an ejection-port surface, and FIG. 6D is a view seen from an opposite side, that is, the liquid ejection unit support portion 81 side.

A plurality of support members 30 arranged in the Y direction is disposed on the first flow path member 50, and one recording element substrate 10 is disposed on each support member 30. With such a configuration, by adjusting the number of ejection modules 200 arranged, recording heads 3 of various sizes can be assembled.

As illustrated in FIG. 6A, a surface of the support member 30 that contacts the recording element substrate 10 is formed with a support-member communication opening 31 that is fluidly connected to the recording element substrate 10 and serves as the individual supply flow path 213a and the individual collection flow path 213b described with reference to FIG. 3. As illustrated in FIG. 6B, the support-member communication opening 31 fluidly communicates with the common supply flow path 211 or the common collection flow path 212 via a communication opening 51 formed in the first flow path member 50.

As illustrated in FIG. 6C, in a middle layer of the first flow path member 50, common flow path grooves 61 and 62 are formed which extend in the Y direction and serve as the common supply flow path 211 and the common collection flow path 212 described with reference to FIG. 3A and FIG. 3B. As illustrated in FIG. 6D, a common communication opening 63 that fluidly communicates with the liquid supply unit 220 is formed at both ends or at one end of the common flow path grooves 61 and 62.

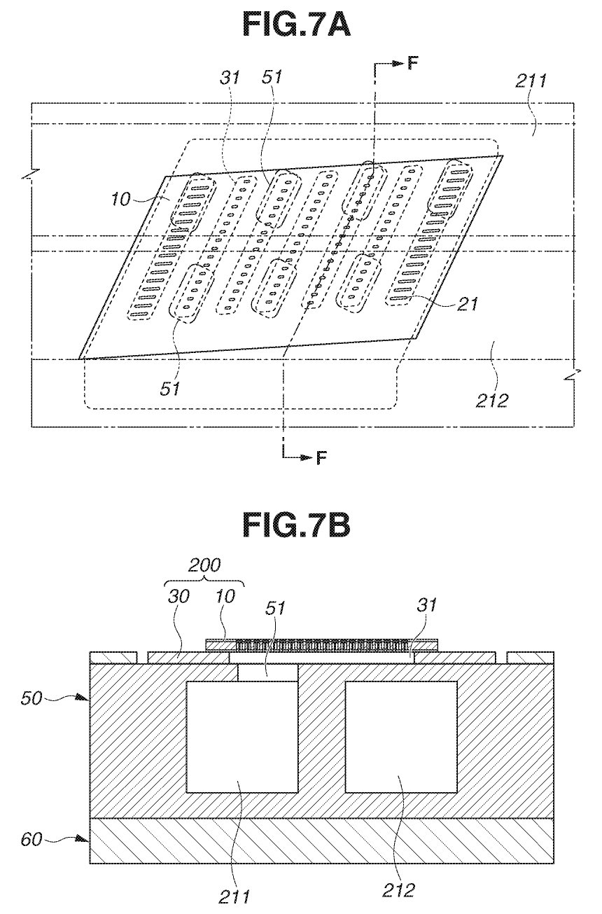

FIG. 7A and FIG. 7B are a transparent perspective view and a cross-sectional view for describing a flow path structure formed inside the flow path member 210. FIG. 7A is an enlarged transparent perspective view of the flow path member 210 as viewed from the Z direction, and FIG. 7B is a cross-sectional view taken along line F-F in FIG. 7A.

The recording element substrate 10 of the ejection module 200 is placed, via the support member 30, over the communication opening 51 in the first flow path member 50. In FIG. 7B, the communication opening 51 corresponding to the common collection flow path 212 is not illustrated, but the communication opening 51 corresponding to the common collection flow path 212 is illustrated in another cross section, as is apparent from FIG. 7A.

As described above, the common supply flow path 211 is connected to a first unit of the negative pressure control unit 230 having a relatively high pressure, and the common collection flow path 212 is connected to a second unit of the negative pressure control unit 230 having a relatively low pressure. An ink supply path for supplying ink to a flow path formed in the recording element substrate 10 is formed through the common communication opening 63 (see FIG. 6), the common supply flow path 211, and the support-member communication opening 31. Similarly, an ink collection path is formed by a flow path in the recording element substrate 10, the support-member communication opening 31, the communication opening 51, the common collection flow path 212, and the common communication opening 63 (see FIG. 7). While ink is circulated in this manner, an ejection operation is performed in the recording element substrate 10 in accordance with ejection data, and ink that is supplied through the ink supply path and is not consumed by the ejection operation is collected through the ink collection path.

### Description of Ejection Module

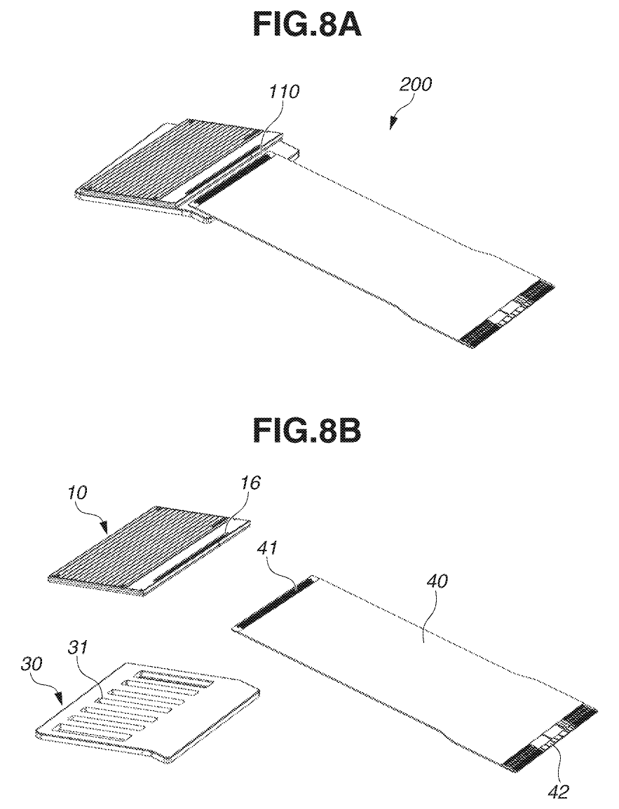

FIG. 8A is a perspective view illustrating one ejection module 200, and FIG. 8B is an exploded view of the ejection module 200. As a manufacturing method of the ejection module 200, the recording element substrate 10 and the flexible wiring board 40 are first bonded to the support member 30 in which the support-member communication opening 31 is provided in advance. Next, a terminal 16 on the recording element substrate 10 and a terminal 41 on the flexible wiring board 40 are electrically connected by wire bonding, and then a wire bonding portion (an electrical connection portion) is covered with a sealing material 110 to be sealed. A terminal 42 on a side of the flexible wiring board 40 opposite to the recording element substrate 10 is electrically connected to a connection terminal 93 of the electrical wiring board 90 (see FIG. 5). The support member 30 is a support body that supports the recording element substrate 10 and is also a flow path member that fluidly communicates the recording element substrate 10 with the flow path member 210, and thus a member having high flatness and capable of being joined to the recording element substrate with sufficiently high reliability is used. For example, alumina or a resin material is used as a material.

### Description of Structure of Recording Element Substrate

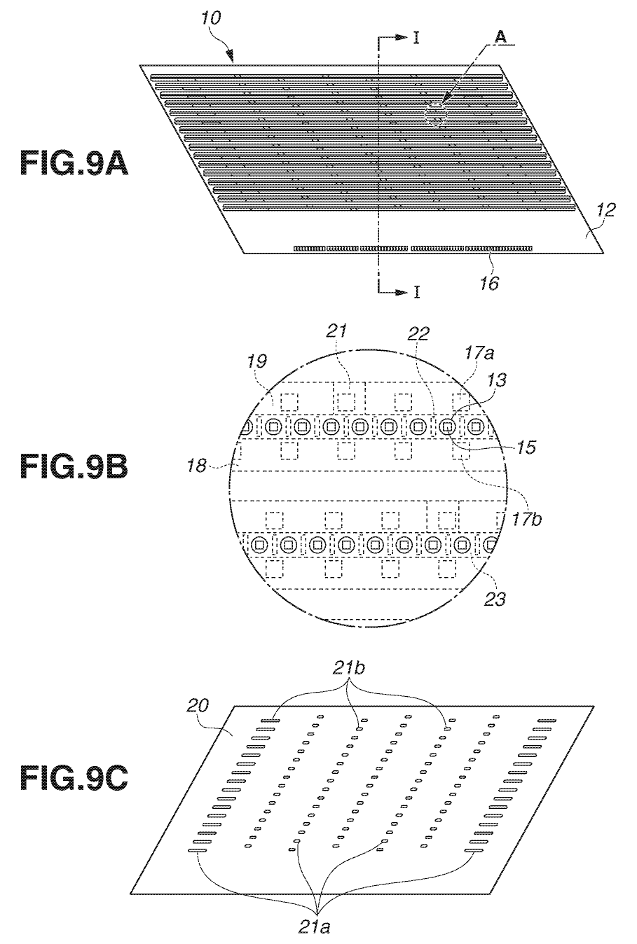

FIG. 9A is a plan view of a surface of the recording element substrate 10 on a side on which ejection ports 13 are formed. FIG. 9B is an enlarged view of a portion indicated by A in FIG. 9A. FIG. 9C is a plan view of a back surface of FIG. 9A. A configuration of the recording element substrate 10 in the present embodiment will now be described. Hereinafter, a direction in which an ejection port array in which a plurality of ejection ports 13 is arranged extends is referred to as an ejection-port-array direction (a first direction). A direction intersecting the first direction is referred to as a second direction, and a plurality of ejection port arrays is arranged in the second direction.

As illustrated in FIG. 9B, a recording element 15 that is an energy generating element configured to generate thermal energy for discharging liquid from an ejection port is disposed at a position corresponding to each ejection port 13. Examples of the energy generating element include a heating element (heater) for generating bubbles by using generated thermal energy. A partition wall 22 defines a pressure chamber 23 including the recording element 15 therein. The recording element 15 is electrically connected to the terminal 16 by electrical wiring (not illustrated) provided in the recording element substrate 10. The recording element 15 generates heat based on a pulse signal input from a control circuit of the recording apparatus 1000 via the electrical wiring board 90 (see FIG. 5) and the flexible wiring board 40 (see FIG. 8) to boil the liquid. The liquid is ejected from the ejection port 13 by a force of bubbling due to the boiling. As illustrated in FIG. 9B, along each ejection port array, a liquid supply passage 18 extends on one side and a liquid collection passage 19 extends on the other side. The liquid supply passage 18 and the liquid collection passage 19 are flow paths provided in the recording element substrate 10 and extending in the ejection-port-array direction, and the liquid supply passage 18 and the liquid collection passage 19 communicate with the ejection ports 13 via a supply port 17a and a collection port 17b, respectively.

As illustrated in FIG. 9C, a sheet-shaped cover plate 20 is laminated on a back surface of the surface of the recording element substrate 10 on which the ejection ports 13 are formed, and a plurality of openings 21 communicating with the liquid supply passage 18 and the liquid collection passage 19 described below is provided in the cover plate 20. In the present embodiment, four supply openings (liquid supply openings) 21a are provided in the cover plate 20 for one liquid supply passage 18, and three collection openings (liquid collection openings) 21b are provided in the cover plate 20 for one liquid collection passage 19. The number of openings is not limited to this configuration. As illustrated in FIG. 9B, each opening 21 in the cover plate 20 communicates with the communication opening 51 illustrated in FIG. 7A. It is desirable for a cover plate 20 having sufficiently high corrosion resistance to a liquid to be used, and high accuracy is required for an opening shape and an opening position of the opening 21 so that ink is supplied to the pressure chamber 23. For this reason, as a material of the cover plate 20, a photosensitive resin material or a silicon plate can be used, and the openings 21 can be formed by a photolithography process. A thickness of the cover plate 20 is desirably about 30 μm to 600 μm from viewpoints of strength and processability.

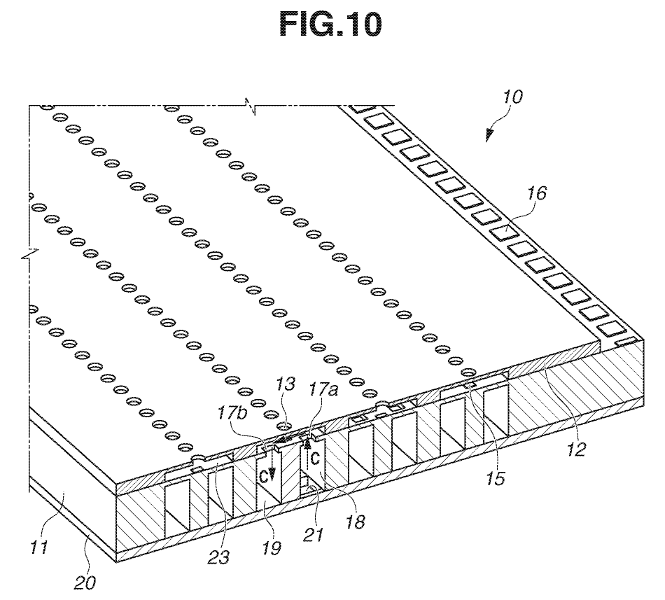

FIG. 10 is a perspective view illustrating a cross section of the recording element substrate 10 and the cover plate 20 taken along line I-I in FIG. 9A. In FIG. 10, four ejection port arrays are illustrated in an ejection-port forming member 12 of the recording element substrate 10, but the present disclosure is not limited to such a number, and a larger or smaller number of ejection port arrays can be employed. A flow of a liquid in the recording element substrate 10 will now be described. The cover plate 20 functions as a lid that forms a portion of walls of the liquid supply passage 18 and the liquid collection passage 19 formed in a substrate 11 of the recording element substrate 10. The recording element substrate 10 includes the substrate 11 formed of Si or the like and the ejection-port forming member 12 formed of a photosensitive resin, and the cover plate 20 is joined to a back surface of the substrate 11. The recording element 15 is formed on one surface side of the substrate 11 (see FIG. 9), and grooves constituting the liquid supply passage 18 and the liquid collection passage 19 extending along the ejection port arrays are formed on a back surface side of the substrate 11. The liquid supply passage 18 and the liquid collection passage 19 formed with the substrate 11 and the cover plate 20 are respectively connected to the common supply flow path 211 and the common collection flow path 212 in the flow path member 210, and a differential pressure is generated between the liquid supply passage 18 and the liquid collection passage 19. Due to the differential pressure, the liquid in the liquid supply passage 18 provided in the substrate 11 flows to the liquid collection passage 19 via the supply port 17a, the pressure chamber 23, and the collection port 17b (arrow C in FIG. 10). With this flow, in the ejection port 13 and the pressure chamber 23 that are not performing an ejection operation, viscosity-increased ink, bubbles, foreign matter, and the like generated by evaporation from the ejection port 13 can be collected into the liquid collection passage 19. In addition, an increase in viscosity of ink in the ejection port 13 and the pressure chamber 23 and an increase in concentration of a coloring material can be suppressed. A liquid collected into the liquid collection passage 19 is collected, through the openings 21 in the cover plate 20 and the support-member communication openings 31 in the support members 30, in an order of the support-member communication opening 31, the communication opening 51 in the first flow path member 50, and the common collection flow path 212, and is then collected into a supply path of the recording apparatus (FIG. 3).

### Description of Condensation

Condensation that occurs on a chip surface will now be described. First, a mechanism by which condensation occurs in Japanese Patent Laid-Open No. 2017-124614 described above will be described. In a liquid ejection head described in Japanese Patent Laid-Open No. 2017-124614, a liquid supplied to a head flows from a supply opening through a supply passage, a pressure chamber, and a collection passage to a collection opening. With this flow, heat generated by discharge or temperature control is transported, and thus a temperature tends to rise in a vicinity of the collection opening. In addition, because the vicinity of the supply opening is cooled by a temperature of supplied ink, a temperature tends to decrease in the vicinity of the supply opening. In addition, because the openings are provided so as to be shifted from the same straight line, some supply openings may be configured such that, on the same straight line in a moving direction of a recording medium, corresponding collection openings are provided on an upstream side in a conveyance direction. Therefore, a relatively warm collection opening may be disposed on an upstream side in the conveyance direction, and a relatively cool supply opening may be disposed on a downstream side in the conveyance direction. When ejection is performed in this state, relatively warm water vapor generated by ejection in the vicinity of the collection opening disposed on the upstream side may be conveyed downstream, causing condensation in a vicinity of the relatively cool openings disposed on the downstream side.

When ejection is continuously performed in such a state for a long time, condensation may accumulate on the supply openings disposed on the downstream side, and an accumulated condensation droplet may exist in a vicinity of an ejection port. In such a case, a liquid may not be normally ejected from the ejection port, and thus print quality may be degraded.

Accordingly, in the present disclosure, a liquid can be circulated through a pressure chamber corresponding to an ejection port to suppress ejection failure due to an increase in viscosity of the liquid, and a temperature difference between recording element substrates is suppressed even at a high printing speed, so that high image quality can be maintained for a long time.

### Description of Comparative Example

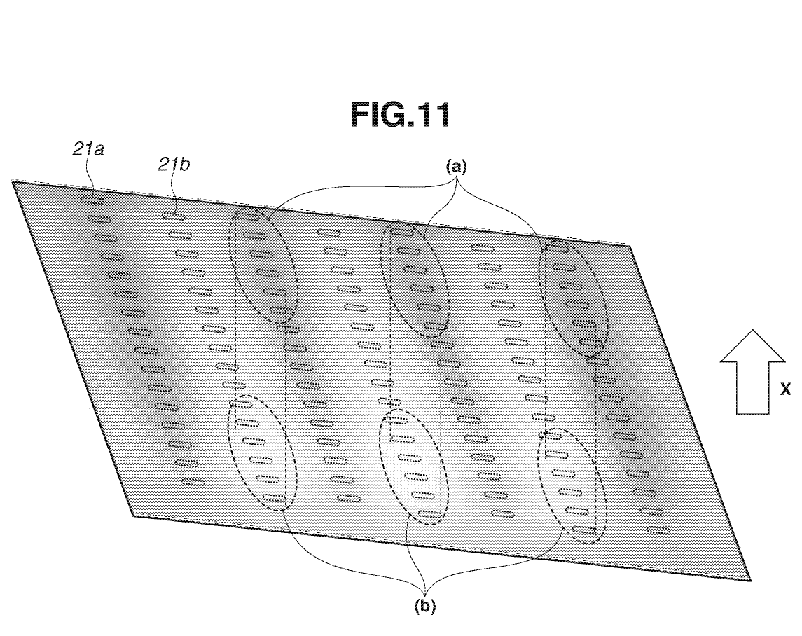

FIG. 11 is a schematic diagram illustrating a temperature distribution of an element substrate in the present embodiment, in which a bright portion indicates a region at a temperature of about 48°C and a dark portion indicates a region at a temperature of about 44°C. In a chip, an ink flow occurs from a supply opening to a collection opening, and with this flow, heat generated by ejection or temperature control is transported, and thus a temperature tends to rise in a vicinity of the collection opening. In contrast, because the vicinity of the supply opening is cooled by a temperature of supplied ink, a temperature relatively tends to decrease in a vicinity of the supply opening. When a temperature difference is generated in the chip in this manner, ejection characteristics vary accordingly and may affect a printed material. To suppress such an influence, the supply opening and the collection opening are disposed so as to be shifted and not aligned on the same straight line with respect to a recording-medium moving direction.

However, since the openings are provided so as to be shifted from the same straight line, some supply openings may be configured such that, on the same straight line in a moving direction (a conveyance direction) X of a recording medium, corresponding collection openings are provided on an upstream side in the conveyance direction. As a result, a relatively warm collection opening may be disposed on an upstream side in the conveyance direction, and a relatively cool supply opening may be disposed on a downstream side in the conveyance direction. For example, in FIG. 11, supply openings (a) in FIG. 11 have a relatively low surface temperature in a chip, but collection openings (b) in FIG. 11 are disposed on an upstream side of the supply openings in the conveyance direction, and the collection openings have a relatively high surface temperature. When a printing operation is performed in this state, relatively warm water vapor generated by ejection in a vicinity of the collection openings (b) in FIG. 11 disposed on the upstream side may be conveyed downstream and may cause condensation on the relatively cool openings (a) in FIG. 11 disposed on the downstream side. When ejection is continuously performed in such a state for a long time, condensation may accumulate on the supply openings disposed on the downstream side, and an accumulated condensation droplet may exist in a vicinity of an ejection port. In such a case, a liquid may not be normally ejected from the ejection port, and thus print quality may be degraded. A chip surface may be cleaned by a method in some manner before condensation droplets affect a printed material, but in such a case, printing is stopped each time cleaning is performed, and thus an issue, such as decreased productivity, occurs.

### Description of Example

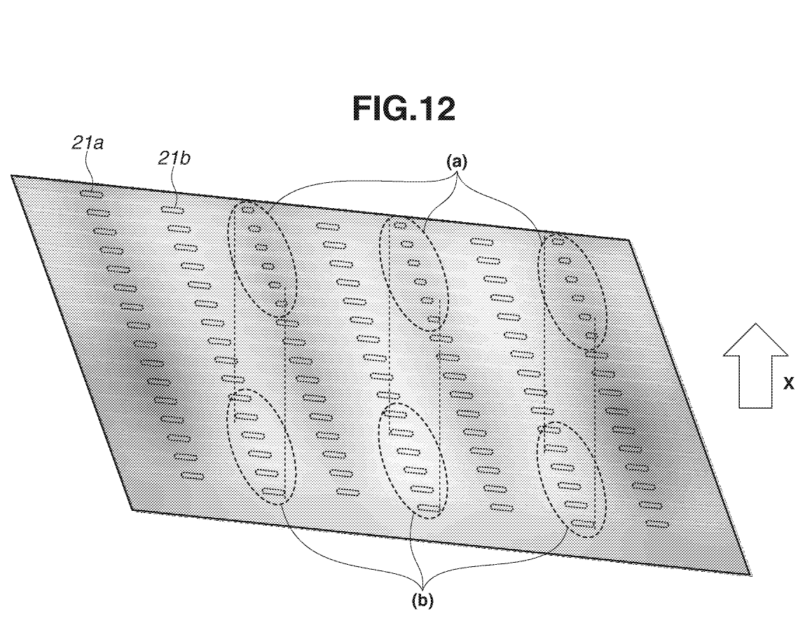

Next, a configuration and effects of the present example will be described. FIG. 12 is a schematic diagram illustrating a temperature distribution of an element substrate in the present embodiment, in which, as described above, a bright portion indicates a region of a temperature of 48°C and a dark portion indicates a region of a temperature of about 44°C. In the present embodiment, among supply openings, an opening area of supply openings for which, on the same straight line in a moving direction of a recording medium, corresponding collection openings are provided on an upstream side in a conveyance direction is smaller than an opening area of other supply openings. That is, an opening area of a first liquid supply opening is equal to or smaller than an opening area of a second liquid supply opening. For example, an opening area of the supply openings (a) in FIG. 12 is half an opening area of other supply openings. Therefore, a flow rate of ink flowing into the corresponding supply openings is reduced, and thus a temperature in a vicinity of the corresponding supply openings is less likely to decrease, and thus a temperature difference between upstream and downstream in the conveyance direction is reduced. For example, in the comparative example, a temperature difference is about 4°C, whereas in the present example, a temperature difference is reduced to about 2°C. When a printing operation is performed in this state, even if water vapor generated by ejection in the vicinity of the collection openings (b) in FIG. 12 disposed on an upstream side is conveyed downstream and reaches the supply openings (a) in FIG. 12, occurrence of condensation is suppressed, and a favorable ejection state can be maintained for a long time. Therefore, favorable printing can be continuously performed without performing a maintenance operation for a long time.

### Case Where Supply Opening Is Hot

The above description has been provided for a case where, because ink flowing into the head is temperature-controlled on a recording element substrate, a temperature of a supply opening becomes lower than a temperature of a collection opening. However, the configuration of the present disclosure is not limited to this case, and can also be applied to a case where the temperature of the supply opening becomes higher than the temperature of the collection opening. For example, in a case where a very high-viscosity ink, such as an ultraviolet-curable ink, is used, a heating element can be provided in a flow path member on a path up to a point at which ink is supplied to a recording element substrate, to heat the ink and reduce a viscosity of the ink before the ink reaches the recording element substrate, thereby facilitating ink transport. In this case, because heat of ink that has reached the recording element substrate escapes from a substrate surface, an ink temperature at a time when ink reaches a collection port becomes lower than an ink temperature supplied to a supply port. When a printing operation is performed in this state, relatively warm water vapor generated by ejection in a vicinity of the supply opening disposed on an upstream side may be conveyed downstream and may cause condensation on the relatively cool collection opening disposed on a downstream side. If ejection is continuously performed in such a state for a long time, condensation may accumulate on the collection opening disposed on the downstream side, and an accumulated condensation droplet may exist in a vicinity of an ejection port. In such a case, a liquid may not be normally ejected from the ejection port, and thus print quality may be degraded. In this configuration, among supply openings, an opening area of supply openings for which, on the same straight line in a moving direction of a recording medium, corresponding collection openings are provided on a downstream side in a conveyance direction, is made smaller than an opening area of other supply openings. In this case, a flow rate of ink flowing into the corresponding supply openings is reduced, and thus a temperature in a vicinity of the corresponding supply openings is less likely to increase, and thus a temperature difference between upstream and downstream in the conveyance direction is reduced. When a printing operation is performed in this state, even if water vapor generated by ejection in the vicinity of the supply openings disposed on the upstream side is conveyed downstream and reaches the collection openings, occurrence of condensation is suppressed, and a favorable ejection state can be maintained for a long time. Therefore, favorable printing can be continuously performed without performing a maintenance operation for a long time.

According to the present disclosure, it is possible to provide a liquid ejection head and a liquid ejection apparatus that suppress occurrence of condensation and improve ejection stability of a liquid.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-044142, filed March 18, 2025, which is hereby incorporated by reference herein in its entirety.

What is claimed is:

1. A liquid ejection head comprising:
an element substrate including:
a first ejection port array in which a plurality of ejection ports configured to eject a liquid is arranged in a first direction;
a second ejection port array that is disposed, with respect to the first ejection port array, in a second direction intersecting the first direction and in which the plurality of ejection ports configured to eject the liquid is arranged in the first direction;
a plurality of pressure chambers each provided to a corresponding ejection port of the plurality of ejection ports and each including an energy generating element configured to generate thermal energy for ejecting the liquid from the corresponding ejection port;
a first supply passage configured to supply the liquid to the plurality of pressure chambers of the first ejection port array;
a second supply passage configured to supply the liquid to the plurality of pressure chambers of the second ejection port array;
a first liquid supply opening configured to supply the liquid to the first supply passage; and
a second liquid supply opening configured to supply the liquid to the second supply passage,
wherein an opening area of the first liquid supply opening is equal to or smaller than an opening area of the second liquid supply opening.

2. The liquid ejection head according to claim 1, wherein the element substrate includes:
a first collection passage configured to collect the liquid from the plurality of pressure chambers of the first ejection port array;
a second collection passage configured to collect the liquid from the plurality of pressure chambers of the second ejection port array;
a first liquid collection opening configured to collect the liquid from the first collection passage; and
a second liquid collection opening configured to collect the liquid from the second collection passage.

3. The liquid ejection head according to claim 2, wherein the first liquid supply opening is disposed, in the second direction, at a position at which the second liquid collection opening is disposed.

4. A liquid ejection apparatus comprising:
a liquid ejection head configured to eject a liquid onto a recording medium; and
a conveying unit configured to convey the recording medium in a conveyance direction,
wherein the liquid ejection head includes an element substrate including:
a first ejection port array in which a plurality of ejection ports configured to eject the liquid is arranged in a first direction;
a second ejection port array that is disposed, with respect to the first ejection port array, in a second direction intersecting the first direction and in which a plurality of the ejection ports configured to eject the liquid is arranged in the first direction;
a plurality of pressure chambers each provided to a corresponding ejection port of the plurality of ejection ports and each including an energy generating element configured to generate thermal energy for discharging the liquid from the corresponding ejection port;
a first supply passage configured to supply the liquid to the plurality of pressure chambers of the first ejection port array;
a second supply passage configured to supply the liquid to the plurality of pressure chambers of the second ejection port array;
a first liquid supply opening configured to supply the liquid to the first supply passage; and
a second liquid supply opening configured to supply the liquid to the second supply passage,
wherein an opening area of the first liquid supply opening is equal to or smaller than an opening area of the second liquid supply opening.

5. The liquid ejection apparatus according to claim 4, wherein the element substrate includes:
a first collection passage configured to collect the liquid from the plurality of pressure chambers of the first ejection port array;
a second collection passage configured to collect the liquid from the plurality of pressure chambers of the second ejection port array;
a first liquid collection opening configured to collect the liquid from the first collection passage; and
a second liquid collection opening configured to collect the liquid from the second collection passage.

6. The liquid ejection apparatus according to claim 5, wherein the first liquid supply opening is disposed, in the second direction, at a position at which the second liquid collection opening is disposed.

7. The liquid ejection apparatus according to claim 6, wherein the first liquid supply opening is provided on a downstream side in the conveyance direction with respect to the second liquid collection opening.

8. The liquid ejection apparatus according to claim 6, wherein the first liquid supply opening is provided on an upstream side in the conveyance direction with respect to the second liquid collection opening.
